(19) United States
(12) Patent Application Publication
(10) Pub. No.: US 2026/0222331 A1
(43) Pub. Date: Jul. 30, 2026

(54) Self-Service Network Reconciliation based on User Experience Scoring

(71) Applicant: Zscaler, Inc., San Jose, CA (US)

(72) Inventors: Gopi Selvarajan, Santa Clara, CA (US); Sreeni Tellakula, San Jose, CA (US)

(73) Assignee: Zscaler, Inc., San Jose, CA (US)

(21) Appl. No.: 19/040,761

(22) Filed: Jan. 29, 2025

(51) Int. Cl. H04L 45/02; H04L 45/00

(52) U.S. Cl. CPC H04L 45/04; H04L 45/22; H04L 45/70

(57) ABSTRACT

Systems and methods for self-service network reconciliation improve network performance in a cloud-based system by using an SDN controller to dynamically optimize routing paths. The SDN controller receives route information from BGP speakers and gathers user experience metrics—such as latency, jitter, or packet loss—to evaluate whether current routes meet performance or SLA targets. If a route falls short, the controller applies a smart routing algorithm to select an alternative path that better satisfies performance criteria. It then updates BGP attributes accordingly, causing traffic to shift to the improved route and enhancing overall user experience.

### FIELD OF THE DISCLOSURE

The present disclosure generally relates to computer and networking systems and methods. More particularly, the present disclosure relates to systems and methods for self-service network reconciliation based on user experience scoring.

### BACKGROUND OF THE DISCLOSURE

Cloud computing operates as a dynamic environment where users can access Internet resources, Software-as-a-Service (SaaS) applications, and even private internal systems through virtualized, on-demand infrastructures. When a user requests access to a service—such as a web-based application, a corporate database, or a customer relationship management (CRM) platform—the cloud's underlying infrastructure automatically provisions the necessary computing, storage, and network resources from a centralized or distributed set of nodes. These nodes are maintained in secure data centers and are managed through layers of abstraction and automation that ensure scaling, load balancing, and redundancy. As a result, users can seamlessly gain access to a wide range of applications via a simple web browser or dedicated client, without having to worry about hardware procurement, server configuration, or routine maintenance.

In addition, the cloud provides tools and frameworks to measure user experience in real-time. Performance metrics such as application response times, network latency, packet loss, and bandwidth utilization can be continuously monitored by integrated analytics platforms. These metrics, combined with user engagement data and transaction monitoring, allow cloud service providers and application owners to gain deep insights into how the services are performing across different geographies, devices, and network conditions. By using these analytics, organizations can refine their infrastructure configurations, proactively address potential bottlenecks, and optimize application code to ensure a smoother, more responsive experience for all users. This dynamic, data-driven approach to resource delivery and performance monitoring forms the core of how the cloud works to enhance connectivity, service delivery, and overall user experience.

### BRIEF SUMMARY OF THE DISCLOSURE

The present disclosure relates to systems and methods for self-service network reconciliation based on user experience scoring. Cloud nodes currently face difficulties rerouting traffic beyond the default routes dictated by their routing peers, even though first-mile ISP stability remains intact. As a result, downstream service degradation across multiple Tier 1 and Tier 2 carriers ultimately lowers the overall User Experience score. To enable cloud nodes to dynamically re-route traffic to alternative Internet service providers (ISPs) when there is a downstream network service degradation across a few network hops, one approach is to deploy a software-defined networking (SDN) controller in the cloud alongside native border gateway protocol (BGP) speakers. The SDN controller can communicate with the BGP speaker using standardized interfaces such as generic remote procedure call (gRPC), or other native application programming interfaces (APIs), enabling real-time route adjustments and policy updates.

The BGP speaker, once integrated with the local data center's BGP session, can influence the routing decision process by injecting new routing policies that prioritize more reliable autonomous system (AS) paths. These policies could include leveraging policy-based routing (PBR) techniques to select routes based on defined criteria rather than strictly following the shortest path. The speaker can also employ a combination of route updates with higher priority metrics, autonomous system number (ASN) filters to prefer or reject certain autonomous systems, and advanced flow programming methods via native routing protocols, software development kits (SDKs), or OpenFlow rules. By employing these layered controls and granular routing policies, the cloud infrastructure gains greater agility in navigating around network congestion, thereby enhancing end-to-end service quality and maintaining a higher User Experience score.

### BRIEF DESCRIPTION OF THE DRAWINGS

The present disclosure is detailed through various drawings, where like components or steps are indicated by identical reference numbers for clarity and consistency.

FIG. 1 illustrates a network diagram of a cloud-based system, depicting how various endpoints can securely interact with the Internet, Software-as-a-Service (SaaS) offerings, other public and private clouds, on-premises data centers, and similar networked resources.

FIG. 2 illustrates a network diagram of an example implementation of the cloud-based system of FIG. 1.

FIG. 3 illustrates a block diagram of a computing system, which may be used as a foundational component in the cloud-based system of FIGS. 1 and 2, at the endpoints, within the nodes, the central authority, or other related systems, as well as in standalone applications.

FIG. 4 illustrates a network with components of the cloud-based system of FIGS. 1 and 2 connected to three different to access an application for an endpoint.

FIG. 5 illustrates a flowchart of a process for dynamically optimizing network routes in a cloud-based system of FIGS. 1 and 2.

### DETAILED DESCRIPTION OF THE DISCLOSURE

Again, the present disclosure relates to systems and methods for self-service network reconciliation based on user experience scoring. As described herein, self-service network reconciliation means rerouting network traffic in a cloud to different ISPs based on network degradation.

### Example Cloud-Based System Architecture

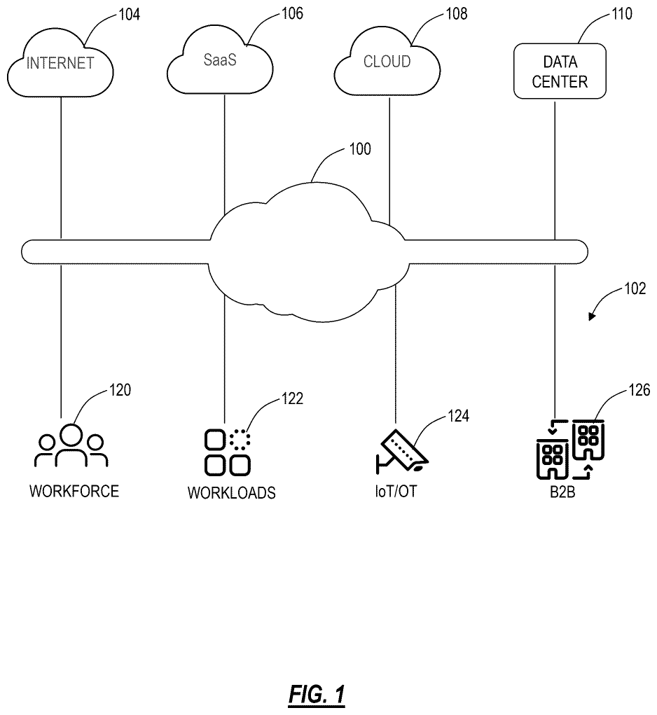

FIG. 1 illustrates a network diagram of a cloud-based system 100, depicting how various endpoints 102 can securely interact with the Internet 104, Software-as-a-Service (SaaS) offerings 106, other public and private clouds 108, on-premises data centers 110, and similar networked resources. These endpoints 102 encompass a broad array of entities, including user devices 120 (e.g., laptops, smartphones, tablets) operated by a workforce such as a company's employees, as well as workloads 122 (e.g., virtual machines, containers, and serverless applications running in the cloud), Internet-of-things (IoT) and operational technology (OT) devices 124 (e.g., sensors, robotic equipment, and embedded systems), and business-to-business (B2B) applications 127 (e.g., partner-facing APIs, supply chain management portals, and shared databases).

At the core of the cloud-based system 100 is a comprehensive, integrated platform designed to deliver a variety of advanced services to these endpoints 102. Among the key example capabilities provided are: cyber protections services, data protection and compliance, zero trust networking, private application access, risk management and security analytics, and the like. Cyber protection services focus on threat prevention, detection, and response. They may include next-generation firewalls, intrusion detection and prevention systems, and advanced malware protection. The cloud-based system 100 can perform real-time analysis of network traffic, user behavior, and application data, using machine learning and threat intelligence feeds to identify malicious activities, quarantine suspicious endpoints, and block attacks before they infiltrate critical resources.

Data protection and compliance ensure the confidentiality, integrity, and availability of data is paramount. The cloud-based system 100 may offer robust encryption at rest and in transit, secure data backup and recovery solutions, and data loss prevention (DLP) policies to safeguard sensitive corporate information. It can also facilitate compliance with industry standards and regulatory frameworks such as GDPR, HIPAA, or PCI-DSS by enforcing consistent data governance policies and automating audit reporting.

With zero trust networking, the cloud-based system 100 can implement a zero-trust security model, where no endpoint 102, i.e., user, device, or application, is inherently trusted—regardless of its location. This includes continuous verification of user identities, device health checks before granting access, and microsegmentation of the network to isolate workloads. The goal is to minimize the lateral movement of threats within the environment and ensure that each access request to an application or dataset is authenticated and authorized in real time.

For private application access, beyond protecting resources that are publicly accessible, the cloud-based system 100 can also securely connect remote employees, contractors, and partners to internal applications hosted in data centers or private clouds. By leveraging technologies such as software-defined perimeters (SDP) and identity-based access controls, the solution helps ensure that only authenticated, authorized users can reach private systems—without the need for exposing those systems directly to the Internet.

For risk management and security analytics, the cloud-based system 100 may integrate advanced analytics, reporting, and visualization tools to support proactive risk management. Security teams can gain insight into the overall posture of the organization's infrastructure, detect patterns and trends in threat activity, and prioritize remediation efforts. This can include risk scoring for endpoints, continuous compliance monitoring, and scenario-based simulations to improve cyber resilience strategies.

Collectively, these services form a holistic defensive posture, enabling organizations to protect their most valuable assets—data, intellectual property, and critical applications—while maintaining efficiency, ensuring compliance, and enhancing productivity. The cloud-based system 100 thus operates as a strategic hub, orchestrating security, access control, and data management across users, devices, workloads, and hybrid information technology (IT) environments.

In operation, the cloud-based system 100 is architected to function inline, continuously inspecting and analyzing traffic flowing to and from the endpoints 102 before it reaches its intended destination. By acting as a secure intermediary, this cloud-based system 100 can apply advanced security policies, real-time threat detection, and data protection measures at every network hop, ensuring that no user device 120, workload 122, IoT/OT sensor 124, or B2B application 126 communicates without rigorous scrutiny. This inline monitoring leverages a combination of distributed proxy nodes, software-defined networking, and intelligent routing, allowing each connection to be channeled through a central service layer for comprehensive visibility. As endpoints attempt to access external services like the Internet 104, SaaS platforms 106, or other clouds 108, the system's 100 policy engines and analytics platforms validate users'identities, check the integrity of devices, inspect traffic content for known and emerging threats, and enforce data handling rules. By continuously operating in this manner, the system 100 can detect anomalous activity early, prevent malicious payloads from being delivered, maintain a hardened security posture, and provide actionable insights that help organizations proactively adjust their defenses.

The endpoints 102 can be associated with a specific tenant, which may be an enterprise, corporation, or any type of organization. A tenant represents a group of users, devices, and applications that share a common environment, security policies, and access privileges within the cloud-based system 100. In other words, a tenant encompasses a managed collection of endpoints 102—whether user devices, workloads, IoT/OT endpoints, or B2B applications—that fall under the administrative domain of a particular IT group or security operations team. While the terms tenant, enterprise, organization, corporation, or company are used interchangeably herein, they all refer to some logically defined and jointly managed set of endpoints 102 governed by unified access controls, monitoring, and enforcement measures.

The cloud-based system 100 supports a multi-tenant architecture, meaning multiple distinct tenants—each with its own users, devices, policies, and configurations—can coexist on the same underlying infrastructure without interfering with one another. This architecture ensures strong logical isolation between tenants so that the data, policy definitions, and security controls of one tenant are neither visible to nor accessible by any other tenant. At the same time, the cloud-based system 100 can capitalize on shared infrastructure components such as global threat intelligence feeds, advanced analytics frameworks, and centralized management consoles, thereby delivering economies of scale and performance efficiencies.

One key advantage of multi-tenancy lies in the ability to leverage insights gained from one tenant's experience to instantly benefit others. For example, when a zero-day or zero-hour threat is detected within one tenant's environment, the cloud-based system 100 can immediately propagate remediation measures, updated signatures, or adaptive policy changes to all other tenants. This ensures that protective measures are enforced system-wide almost instantaneously, dramatically reducing the window of exposure for all endpoints 102 connected to the cloud-based system 100. Similarly, adjustments to security policy, configuration settings, or regulatory compliance parameters can be applied globally, streamlining the management effort and maintaining a consistently high security posture across a broad and diverse user base.

Beyond security updates and policy enforcement, the multi-tenant model also facilitates rapid innovation. New features, functionality enhancements, and performance improvements can be rolled out at the platform level and become instantly available to every tenant, without the need to individually update each endpoint 102 or manually upgrade isolated environments. This centralized approach to deploying and improving services reduces maintenance complexity, shortens deployment cycles, and ensures that all tenants benefit simultaneously from the latest capabilities and developments within the cloud-based system 100. In doing so, the cloud-based system 100 not only simplifies security management but also drives continuous improvement and innovation across diverse, global enterprises.

In various implementations, endpoint traffic is directed through the cloud-based system 100 by employing lightweight forwarding applications, secure tunnels, or proxy services that integrate seamlessly with existing network architectures. For instance, an endpoint 102—whether it is a user's laptop, a containerized workload, or an IoT sensor—may run a small forwarding agent installed at the operating system or application layer. This agent captures outbound traffic from the endpoint and redirects it to the cloud-based system 100. Once the traffic is routed to the system's ingress points, secure tunnels (e.g., transport layer security (TLS)- or Internet protocol security (IPsec)-encrypted links) carry the data to specialized processing nodes hosted in the cloud-based system 100.

These tunnels help ensure both confidentiality and integrity, preventing unauthorized observation or manipulation of the traffic in transit. Depending on network topology, tunnels may be established on a per-user, per-application, or per-site basis, offering flexibility in how different classes of endpoints connect to the cloud-based system 100. For branch offices or data center-to-cloud scenarios, site-level tunnels (e.g., via software defined-wide area networking (SD-WAN) appliances or virtual edge devices) can be employed to efficiently forward all outbound traffic to the platform for inspection and control without requiring each individual device to handle encryption and routing tasks.

Once traffic arrives in the cloud-based system 100, it can be managed by a distributed set of cloud nodes. These cloud nodes can terminate and inspect the traffic at the application layer, apply security and data protection policies, and, if allowed, forward it on to its intended destination (e.g., SaaS applications, the Internet, or other cloud environments). Leveraging intelligent routing and load balancing capabilities, the cloud-based system 100 ensures optimal path selection and high availability, distributing traffic across multiple points of presence and enforcing consistent security policies worldwide. This approach also makes it straightforward to enforce zero trust principles—verifying user identities, device health, and contextual factors before granting access, all while being completely transparent to end-users.

Altogether, the combination of endpoint-level forwarding agents, encrypted tunnels, and proxy-based traffic inspection enables the cloud-based system 100 to operate inline at scale, delivering real-time security, data protection, and policy enforcement across a diverse and globally distributed set of endpoints 102 and network environments.

### Example Implementation of the Cloud-Based System

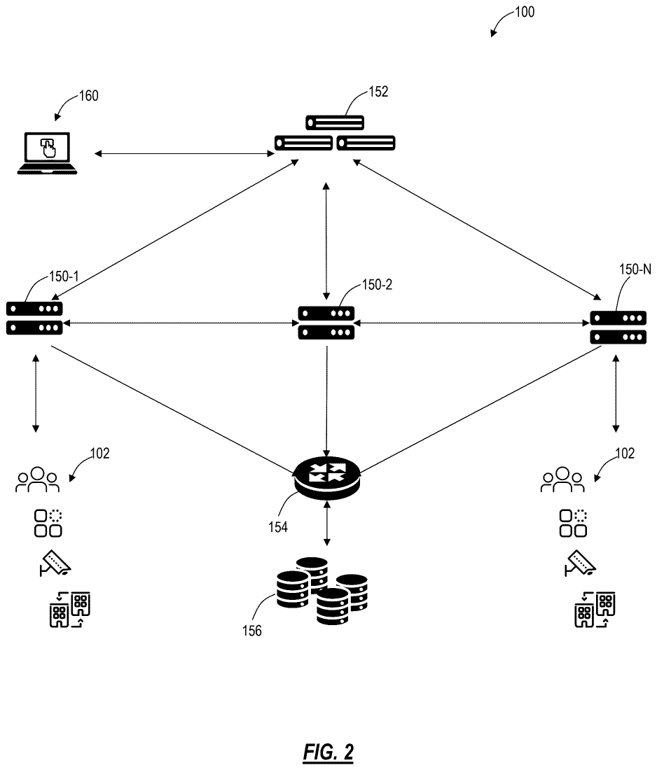

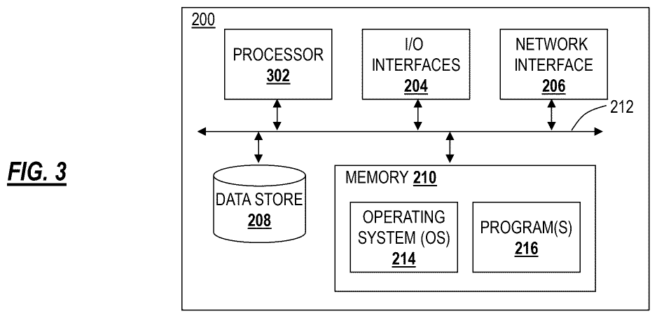

FIG. 2 illustrates a network diagram of an example implementation of the cloud-based system 100. In one embodiment, the cloud-based system 100 includes a plurality of distributed, interconnected nodes 150—labeled as nodes 150-1, 150-2, . . . , 150-N—each of which interfaces with a central authority (CA) 152. While depicted as discrete nodes, these entities can each represent one or more servers, including physical hardware, clustered server environments, or virtualized machines (VMs) running atop shared infrastructure (collectively referred to as a “computing system”). An illustrative example of such a computing system is provided in FIG. 3.

To support scalable log collection and monitoring, the cloud-based system 100 also incorporates a log router 154. This log router 154 serves as a dedicated subsystem that aggregates event data, security alerts, connection metadata, and usage statistics generated by the nodes 150 and directs these logs into a storage cluster 156. The storage cluster 156 can be backed by a highly available and fault-tolerant data store—such as a distributed file system or a cloud-based object storage service—ensuring that logs are securely archived, easily retrievable for forensic analysis, compliance auditing, and performance diagnostics.

The central authority (CA) 152 operates as the system's 100 command and control hub. It provides centralized oversight and coordination by managing global policies, delivering real-time threat intelligence, and orchestrating security configuration updates to each of the nodes 150. For example, when a newly discovered zero-day vulnerability is identified, the CA 152 can immediately push updated rules, signatures, or machine learning models to all nodes. Similarly, when a global configuration change—such as a data protection policy update or a revised regulatory compliance rule—is required, the CA 152 disseminates these changes across the network, ensuring a consistent enforcement posture throughout the cloud-based system 100. For example, user access can be via a UI through a management system 160.

Each node 150 serves as a strategic ingress point (or “onramp”) for endpoint 102 traffic entering the cloud-based platform from users'endpoints 102. The nodes 150 apply the policies and rules received from the CA 152, performing real-time traffic inspection, user authentication, threat detection, data loss prevention, and access control enforcement. This ensures that endpoints 102 receive the same level of protection and policy compliance regardless of their geographic location or the type of network they connect from. In practice, an endpoint 102 attempting to connect to a resource (e.g., the Internet 104, SaaS applications 106, other clouds 108, or data centers 110) is automatically directed to the nearest geographically available node 150—or to a node selected based on load balancing criteria, capacity, or tenant-specific requirements. This location-agnostic approach means that the policy defined by the tenant's IT administrators follows the endpoint 102 wherever it goes, delivering a consistent security posture and user experience across the global footprint of the cloud-based system 100.

Altogether, the interplay of the nodes 150, the central authority 152, the log router 154, and the storage cluster 156 forms a cohesive, cloud-native security and networking fabric. This infrastructure is designed not only for scalability and resilience but also for seamless updates, rapid threat response, and uniform policy enforcement, ensuring that all endpoints 102 benefit from a continuously evolving, high-security environment.

The central authority (CA) 152 functions as the authoritative repository and management layer for all customer (tenant) policies, configuration settings, and global security intelligence within the cloud-based system 100. It hosts a consolidated view of tenant-specific access controls, data protection rules, content filtering parameters, DLP dictionaries, and other contextual security and compliance configurations. Beyond static policy storage, the CA 152 continually monitors the broader network ecosystem—ingesting real-time threat intelligence feeds, detecting emerging security vulnerabilities, and processing regular software and database updates that keep all nodes 150 current with the latest protective measures.

In a multi-tenant cloud model, reliability and resilience are paramount. Therefore, the CA 152 is architected with redundancy and geo-distribution in mind. It is replicated and backed up across multiple data centers and cloud regions, employing load balancing and failover mechanisms that ensure uninterrupted policy availability even if one location experiences downtime. This architecture underpins the system's global reach and guarantees that tenants, regardless of their geographic footprint, benefit from consistent and continuous access to up-to-date policy and threat data.

The nodes 150 maintain persistent, encrypted communication channels with the CA 152 to retrieve these policies and updates. For instance, when a new endpoint 102—such as a user's device or a workload—connects to a given node 150, that node issues a policy request to the CA 152 through the established secure channel. In response, the CA 152 dynamically calculates which rules and restrictions apply to that particular endpoint based on the tenant's configurations and the endpoint's associated attributes (e.g., user identity, device posture, location, etc.). To optimize performance and minimize bandwidth usage, the CA 152 delivers the calculated policy in a highly compressed bitmap format, significantly reducing latency and overhead during policy retrieval.

Once the node 150 receives this policy, it locally caches the tenant's configuration to quickly enforce rules for subsequent requests from the same endpoint 102. This caching mechanism helps maintain efficient policy enforcement, even under high traffic loads, and ensures low-latency responses for end-users. However, the system 100 is designed to adapt dynamically to changes in security conditions or organizational requirements. When an administrator updates a policy through the management system 160—such as revising access privileges, altering disallowed websites, adding new DLP dictionaries, or changing restricted domains—the CA 152 propagates this change by issuing a signal to invalidate all cached policies at the nodes 150.

This invalidation is facilitated by periodic “heartbeat” messages exchanged between the CA 152 and the nodes 150. These heartbeats serve as both a health check and an update signal. When the CA 152 indicates a policy revision, each node 150 recognizes that previously cached policies are no longer valid. As soon as an endpoint 102 makes a new request, the node 150 must pull the updated policy from the CA 152. This ensures that policy enforcement is always synchronized with the latest organizational directives, threat intelligence, and compliance requirements. In sum, the CA 152 provides a centralized, resilient, and continuously updated source of truth for all policy-related decisions across the cloud-based system 100. It seamlessly distributes policies in an efficient manner, accommodates rapid changes, and ensures that every node 150 enforces the most recent and relevant security and compliance guidelines, thereby maintaining a robust, adaptive, and globally consistent security posture.

The cloud-based system 100 can be deployed in various forms, such as a private cloud operating within a single organization's infrastructure, a public cloud hosted by a third-party provider, or a hybrid cloud model combining elements of both to meet unique performance, security, and regulatory needs. Cloud computing methodologies abstract away the complexity of underlying physical resources—such as servers, storage devices, and network infrastructure—and instead present them as on-demand, scalable services. This abstraction enables organizations to dynamically allocate computing power, storage capacity, and network bandwidth, adjusting to fluctuating workloads and business requirements without substantial upfront capital investments.

The U.S. National Institute of Standards and Technology (NIST) defines cloud computing as “a model for enabling convenient, on-demand network access to a shared pool of configurable computing resources (e.g., networks, servers, storage, applications, and services) that can be rapidly provisioned and released with minimal management effort or service provider interaction.” In contrast to traditional client-server models, cloud computing often delivers applications through a web interface, reducing or eliminating the need for client-side installations and version upgrades. Because cloud applications are centrally hosted, service providers can uniformly update features, apply patches, and manage licensing without requiring individual endpoint maintenance. This centralized model not only simplifies IT administration but also ensures that clients always have access to the latest and most secure versions of the applications.

“Software as a Service” (SaaS) is a commonly used term to describe application software provided via cloud computing models. Users access these SaaS solutions through browsers or lightweight client interfaces, taking advantage of continuous improvements and rapid feature releases. The term “the cloud” is often used as shorthand to refer to the entirety of these virtualized computing services or to a specific cloud environment. The cloud-based system 100 described herein represents one such example of a cloud-based solution, and it will be readily understood that other cloud-based architectures, deployment models, and configurations may also be suitable for different use cases and requirements.

### Example Computing System Architecture

FIG. 3 illustrates a block diagram of a computing system 200, which may be used as a foundational component in the cloud-based system 100, at the endpoints 102, within the nodes 150, the central authority 152, or other related systems, as well as in standalone applications. By way of example, multiple instances of the computing system 200 can be combined or distributed to form the nodes 150 and the central authority 152. Conceptually, the computing system 200 can be implemented using various forms of underlying infrastructure, including physical servers, clusters of machines, virtual machines (VMs) running on hypervisors, or serverless computing frameworks. Regardless of its deployment model, the computing system 200 generally includes a processor 202, input/output (I/O) interfaces 204, a network interface 206, a data store 208, and memory 210.

It should be noted that FIG. 3 is a simplified representation of the computing system 200 and that practical implementations may employ additional hardware and software elements (e.g., accelerators, GPUs, FPGAs, dedicated cryptographic modules, caching layers, etc.) as well as more complex interconnect fabrics for high throughput and low latency. The illustrated components (202, 204, 206, 208, and 210) are coupled via a local interface 212, which may include one or more wired or wireless buses, high-speed interconnects, or sophisticated switching fabrics. In addition, the local interface 212 may incorporate a variety of controllers, buffers, caches, drivers, repeaters, and receivers, along with addressing and control lines, to facilitate efficient communication and resource sharing among components.

The processor 202 is a hardware device—such as a central processing unit (CPU), multicore processor, system-on-chip (SoC), or a processing element within a larger compute cluster—designed to execute software instructions. The processor 202 may be a general-purpose processor, a specialized processor, or a combination thereof, and it can be chosen based on performance, power efficiency, or workload requirements. When the computing system 200 operates, the processor 202 retrieves and executes instructions stored in the memory 210, orchestrating data exchanges with the data store 208 and managing the overall operations of the computing system 200. In larger deployments (e.g., the cloud-based system 100), multiple processors 202 and parallel computing architectures may be employed to handle high traffic volumes and complex workloads efficiently.

The I/O interfaces 204 enable the computing system 200 to interact with external peripherals and devices, facilitating input from operators (e.g., through keyboards, touchscreens, or sensors) and output to displays, printers, or other systems. Depending on the application, the I/O interfaces 204 may also support specialized input devices for management, debugging, or maintenance of the system. The network interface 206 provides connectivity to external networks, such as the Internet 104, private corporate networks, or other cloud environments. This interface could be an Ethernet adapter, a Wireless LAN (WLAN) adapter, a 5G modem, or a virtual network interface in a cloud environment. It can support advanced network features like link aggregation, VLAN tagging, or software-defined networking (SDN) overlays. By leveraging secure transport protocols and encryption, the network interface 206 ensures that data exchanged over public or semi-public networks remains protected and that the computing system 200 can participate fully in distributed, cloud-based architectures.

The data store 208 represents storage resources where data can be held persistently or temporarily. Depending on the system requirements, the data store 208 may be implemented using volatile memory (e.g., RAM) for fast, transient storage or nonvolatile media (e.g., solid-state drives, hard disk drives, optical media) for durable, long-term data retention. In certain embodiments, the data store 208 can be integrated with external storage systems, network-attached storage (NAS), storage area networks (SAN), or cloud-based storage services. This flexibility allows the computing system 200 to accommodate various performance and capacity needs, scaling from small-footprint deployments to enterprise-grade installations. Data in the data store 208 may include operational logs, configuration files, policy data, program binaries, and cached results of computations. For example, in the context of the cloud-based system 100, the data store 208 could store threat intelligence feeds, tenant policies, audit trails, analytics results, and more. External or distributed storage solutions can also be integrated, supporting global deduplication, compression, encryption at rest, and multi-site replication for resiliency and disaster recovery.

The memory 210 serves as the primary working memory for the processor 202. It can be composed of volatile memory elements like DRAM (including DDR, SDRAM) for rapid access, or it can include nonvolatile components, such as Flash memory or NVRAM, to provide a balance between speed and persistence. Memory 210 can also be distributed across multiple nodes or servers, enabling large in-memory data processing tasks commonly required by modern cloud applications. The memory 210 typically stores software, including the operating system (O/S) 214 and one or more programs 216. The O/S 214 manages fundamental system operations, such as process scheduling, memory allocation, file management, and network communication. Above the O/S layer, the programs 216 implement the specific logic and functionality described herein. They may include security modules, policy enforcement engines, threat detection algorithms, load balancing routines, or data analytics tools that enable the cloud-based system 100 to function effectively.

In summary, the computing system 200 provides a foundational building block for the cloud-based system 100 and other environments. Its modular, scalable hardware and software components empower the implementation of robust, flexible, and secure services, ensuring reliable operation and efficient execution of complex tasks in a wide range of computing scenarios.

### Network Environment for the Cloud-Based System

The cloud-based system 100 is designed with a carrier-agnostic architecture that enables it to function seamlessly across a wide variety of network environments—ranging from traditional broadband Internet Service Providers (ISPs) to Tier 1 carriers, mobile networks, Tier 2 carriers, and specialized service providers. A key factor in this flexibility is that the system relies on standard, widely adopted network protocols and encryption methods, allowing it to operate transparently over any underlying transport medium without requiring custom integration or proprietary protocols.

From an endpoint's 102 perspective, the cloud-based system 100 typically presents itself as a series of globally distributed access nodes and points of presence (PoPs), each strategically placed in data centers or peering locations worldwide. The nodes 150 connect into regional and international carrier backbones through established interconnects, peering agreements, and Internet Exchange Points (IXPs). As a result, whether an endpoint 102 is on a corporate multiprotocol label switching (MPLS) network, a home broadband connection, a 4G/5G mobile data plan, or a satellite link, it can securely forward traffic into the nearest node 150 using standard IP-based communications. Encryption (e.g., TLS or IPsec) ensures that traffic remains protected, regardless of which carrier's infrastructure it traverses.

### User Experience

Monitoring user experience within the cloud-based system 100 involves deploying a combination of active and passive measurement techniques—referred to generally as “probes” or “traces”—that continuously gauge the performance, reliability, and accessibility of the services consumed by endpoints 102. These probes can be software agents integrated within the nodes 150, the endpoints 102, or even external vantage points designed to mimic end-user transactions. They periodically execute synthetic tests or capture real user traffic patterns to measure key metrics like response time, latency, jitter, and packet loss, i.e., synthetic probes, traces, or Real User Monitoring interfaces. By conducting these tests at regular intervals and from multiple geographic regions, the cloud-based system 100 can generate a detailed performance profile that reflects actual user experience. This can be referred to as a User Experience (UX) score.

When the collected data from these probes indicate a sudden increase in latency, higher-than-expected error rates, or significant drops in throughput, the system 100 can correlate such anomalies with specific network segments, carriers, or paths. For example, if synthetic trace routes or path probes reveal that requests from a certain region suddenly take longer to reach a particular node 150, it may indicate underlying network congestion, routing inconsistencies, or peering issues between the user's ISP and one of the cloud system's backbone providers. Similarly, if passive measurements show a pattern of packet loss spiking whenever traffic passes through a particular network hop, the system can pinpoint that hop as a potential bottleneck or point of failure.

By continually gathering and analyzing these performance indicators, the cloud-based system 100 can proactively detect early signs of network degradation—such as an ISP experiencing congestion during peak hours, a carrier's misconfigured route, or an overloaded PoP (Point of Presence)—long before widespread user-visible outages occur. Armed with this intelligence, operators can escalate the issue to the relevant service provider, reroute traffic along less congested paths, or adjust load-balancing policies to maintain seamless user experience. Over time, historical probe data also enable the system 100 to model expected performance baselines, identify emerging trends, and refine capacity planning or traffic engineering strategies. In essence, these probes and traces form a diagnostic toolset that empowers the cloud-based system 100 to maintain high-quality service delivery, quickly isolate root causes of performance dips, and provide a consistently reliable user experience.

In addition to synthetic probes or traces, Real User Monitoring (RUM) provides a continuous, real-time view of how users actually experience web applications by collecting detailed performance statistics and error information directly from user devices. Instead of relying on snapshots or synthetic tests, RUM captures metrics such as page load times, start of navigation, redirects, DNS lookup durations, HTTP request/response start and end times, domain object model (DOM) load times, page load completion, as well as JavaScript and AJAX errors encountered by the user. Using a lightweight browser add-on or extension, RUM periodically transmits these collected metrics to a cloud-based analytics platform, where administrators can gain end-to-end visibility into true user experience, proactively identify performance bottlenecks, and implement data-driven improvements that optimize overall digital experience.

### Cloud Path

In an embodiment, the user experience in the cloud-based system 100 can be called a cloud path which is an approach to provide a dynamic, visual representation of network performance metrics, illustrating the traffic flow and its intermediate hop points between the endpoint 102, through the cloud-based system 100, and an application or destination. This end-to-end view can help administrators and IT teams quickly identify where latency, packet loss, or network errors occur along the path, facilitating more informed troubleshooting and capacity planning decisions.

The cloud path can capture direct traffic flows—such as from an application or agent on a user's device directly to the egress point and onward to the destination—or more complex paths where traffic first tunnels through the nodes 150 before reaching the ultimate destination. Regardless of the route taken, the cloud path provides granular visibility into each segment of the journey.

### Key Features of the Cloud Path:

Metric Visualization: A time-series graph displays latency or packet loss over a selected time period, enabling you to pinpoint trends or sudden spikes in performance degradation.

Path-Level Insights: A Hop View and Command Line View detail every step in the path from the user's device to the application, including intermediate network segments, service providers, and the cloud-based system 100 infrastructure components.

Commonly, several types of probes or trace techniques can be employed to monitor network paths and performance within the cloud-based system 100. Each method offers unique advantages and may be selected based on the desired level of detail, network conditions, or specific diagnostic needs. Some of the commonly used probes and traces include:

ICMP-Based Probes (Ping): Using ICMP (Internet Control Message Protocol) echo requests and replies—commonly known as ping—provides a straightforward way to measure basic connectivity and round-trip latency between nodes. ICMP probes are widely supported, easy to execute, and can quickly indicate if a path is up, experiencing packet loss, or suffering excessive latency.

UDP-Based Traceroutes: Traditional traceroute tools often default to sending UDP packets with incrementally increasing Time-to-Live (TTL) values. Each hop along the path returns an ICMP “time exceeded” message, revealing both the identity of that intermediate router and the time it took to get there. UDP-based traceroutes are useful when ICMP traffic is deprioritized or filtered, and they can provide more granular path information than a simple ping.

ICMP-Based Traceroutes (ICMP Tracers): Some traceroute implementations use ICMP Echo or Timestamp requests instead of UDP packets. This approach can be beneficial in environments where UDP traffic might be blocked or rate-limited, allowing network administrators to still gain visibility into intermediate hops and their response times.

TCP-Based Traceroutes (TCP Traceroutes): TCP traceroute methods send TCP SYN packets toward a specified destination port. This approach can be valuable for diagnosing issues in environments that filter or block ICMP and UDP probes, or when you need to measure performance on a path specifically relevant to a particular application port (e.g., HTTP on port 80 or HTTPS on port 443). By simulating real application flows, TCP-based traceroutes can provide insight into firewall behaviors, load balancers, or application-layer issues.

Application-Level or Synthetic Probes: Beyond simple network-layer diagnostics, more sophisticated synthetic transactions can be used. For example, sending HTTP GET requests or running DNS lookups at scheduled intervals offers an application-layer view of performance. These synthetic probes can measure total request/response times, simulate user transactions, and detect issues such as slow backend responses or content delivery delays that might not be visible at the pure network layer.

In practice, the cloud-based system 100 can use a combination of these techniques to gain a comprehensive understanding of network conditions. By mixing ICMP, UDP, TCP, and higher-level synthetic probes, the cloud-based system 100 can identify where and why performance issues arise—whether it's a failing intermediate hop, filtering on a particular protocol, or congestion within a specific segment of the network.

### Network Performance Degradation

Scenarios were seen where the User Experience (UX) score declined significantly due to degraded network performance observed across multiple Tier 1 and Tier 2 carriers, despite the first mile—covering the links from the cloud-based system's nodes 150 to the end users'local Internet Service Providers (ISPs)—appearing to function correctly. In other words, the initial access layers and direct connectivity between the cloud nodes 150 and end-user on-ramps were stable, with minimal latency and packet loss. However, beyond this initial boundary, downstream congestion, inconsistent routing, or packet loss within intermediate transit carriers and their interconnects caused noticeable deterioration in service quality as data moved closer to the user's network edge.

This complexity arises from the inherent nature of global Internet routing, which relies heavily on the Border Gateway Protocol (BGP) for path selection. BGP uses a set of pre-negotiated policies, peering agreements, and autonomous system (AS) relationships to determine how traffic traverses the network. While cloud providers often establish robust peering arrangements and maintain diverse connectivity with multiple backbone carriers to achieve broad geographic coverage and redundancy, they remain largely dependent on these carriers to deliver traffic optimally once it leaves their controlled environment.

If certain transit routes become congested, suffer from increased latency, or experience frequent packet drops due to network misconfigurations, capacity oversubscription, or localized failures, the cloud infrastructure has limited real-time flexibility to dynamically circumvent these troubled paths. Traditional BGP routing decisions, influenced by static or semi-static policies, cannot instantly react to sudden performance degradations. Cloud providers typically cannot unilaterally reroute traffic through entirely different carriers or rerank preferred paths on demand, as doing so would require more intricate cooperative frameworks, advanced routing protocols, or negotiated service-level agreements (SLAs) that extend beyond conventional BGP arrangements.

This limitation underscores the need for more adaptive and intelligent routing strategies. Real-time visibility tools, for example, could proactively detect congestion and service drops along specific network segments. These insights, combined with software-defined networking (SDN) principles and next-generation routing protocols, can enable the cloud-based system 100 to reoptimize path selection dynamically. Furthermore, tighter collaboration and standardized interfaces between cloud providers, Tier 1 and Tier 2 carriers, and regional ISPs could open avenues for more granular traffic engineering, proactive route reconfiguration, and priority adjustments that transcend the default BGP policies. Ultimately, these enhanced capabilities would help mitigate downstream network impairments and improve the overall end-to-end UX, ensuring consistently high-quality service delivery across complex, heterogeneous global networks.

### Self-Service Network Reconciliation

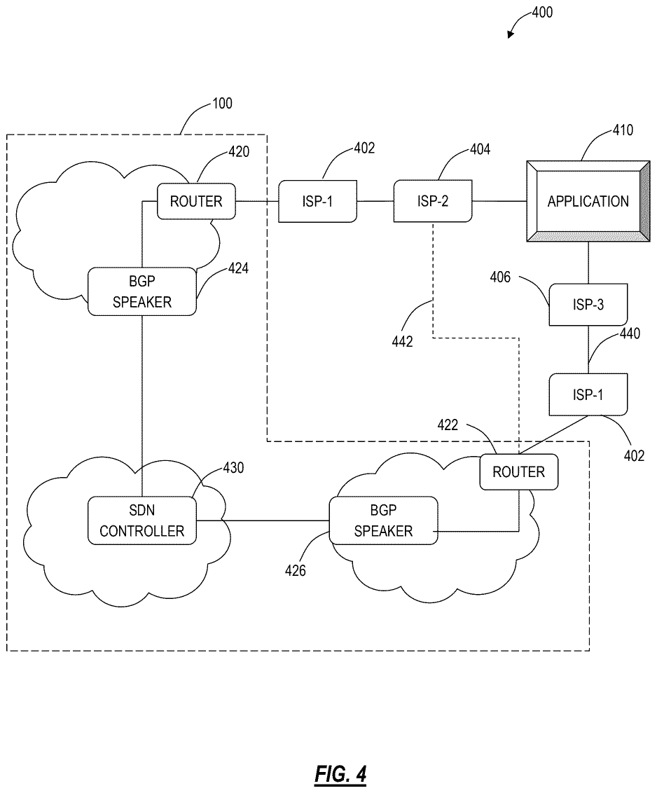

FIG. 4 illustrates a network 400 with components of the cloud-based system 100 connected to three different ISPs 402, 404, 406 to access an application 410 for an endpoint. Note, the endpoint 102 is omitted from FIG. 4 for illustrative purposes, but assume it connects to the cloud-based system 100 as shown and described herein. Also, assume there is user experience monitoring associated with the cloud-based system 100 and the application 410.

In the cloud-based system 100, traffic routing involves a combination of traditional networking elements—such as routers 420, and BGP speakers—together with programmable components like an SDN (Software-Defined Networking) controller 430. Each of these elements plays a distinct but complementary role in ensuring that data flows efficiently, securely, and reliably between the nodes 150 and the broader network environment.

The routers 420, 422 are fundamental building blocks of the network's infrastructure. They operate primarily at the network layer (Layer 3) and are responsible for forwarding packets from one network segment to another based on destination IP addresses. In the cloud-based system 100, the routers 420, 422 form the backbone of connectivity, linking the system's nodes 150 to local ISPs 402, 404, 406, carrier backbones, and peering points with other networks. These devices may be implemented as high-performance hardware appliances or virtualized routers running on commodity servers. The routers 420, 422 ensure that each packet follows an optimal path across the network, balancing factors like latency, bandwidth availability, and link reliability.

BGP is the standard routing protocol used to exchange reachability information among different autonomous systems (ASes) on the Internet 104. A BGP speaker 424, 426 is a router (or a software-based routing component) configured to participate in BGP sessions with external peers, such as Tier 1 or Tier 2 carriers, Internet Exchange Points (IXPs), and other large-scale networks. Within the cloud-based system 100, the BGP speaker 424, 426 announce the IP prefixes that the system's nodes 150 can serve and learn about external routes from upstream and downstream providers. Through BGP, the system 100 discovers available paths across the global Internet, selects preferred routes based on policies and attributes (e.g., AS path length, local preference, MED values), and ensures that traffic exits and enters the system's network at the most advantageous points. Because BGP is policy-driven, it allows the cloud-based system's 100 operators to influence routing decisions, enforce peering agreements, and maintain redundancy and resilience at the edges of the network.

While the routers 420, 422 and the BGP speakers 424, 426 handle external connectivity and path selection, the SDN controller 430 introduces a higher level of abstraction and programmability to the internal network fabric of the cloud-based system 100. Acting as a central brain, the SDN controller 430 maintains a global, real-time view of the network's topology, resource utilization, and policy requirements. Instead of manually configuring each router and switch, network operators define desired outcomes, policies, and constraints within the SDN controller's 430 interface or API. The controller 430 then translates these high-level intents into low-level configuration changes, pushing them out to the underlying network devices. This may involve adjusting traffic engineering parameters, rerouting flows away from congested segments, or dynamically setting quality-of-service (QoS) policies based on current demand. The SDN controller 430 can integrate performance metrics, latency measurements, and even security signals to optimize routing. By doing so, it can respond more quickly to network events than traditional manual methods allow. In certain embodiments, the SDN controller 430 might also interact directly with BGP speakers 424, 426, injecting or modifying routes based on internal policies or real-time traffic conditions, ultimately bridging the gap between the system's internal routing logic and external BGP-driven paths.

In practice, the cloud-based system 100 leverages all three elements—the routers 420, 422, the BGP speakers 424, 426, and the SDN controller 430—to provide robust, adaptable routing for the nodes 150. The BGP speakers 424, 426 handle external connectivity and global route discovery, ensuring the system is reachable and well-peered. The routers 420, 422 form the foundational hardware and software platforms that forward traffic efficiently, providing the building blocks for data movement. The SDN controller 430 orchestrates these underlying components, implementing dynamic policies, reacting to changing network states, and applying sophisticated traffic engineering techniques. Together, these technologies support a scalable, secure, and high-performing network environment that can meet the evolving needs of the cloud-based system's 100 tenants and their endpoints 102.

In an embodiment, the cloud-based system 100 is configured to provide two example services—a user experience service which monitors the cloud-based system 100, the endpoints 102, and associated connectivity through the ISPs 402, 404, 406, and a connectivity service which provides access between the endpoints 102 and associated destinations (the Internet 104, SaaS services 106, other clouds 108, data centers 110, applications, etc.). The SDN controller 430 is associated with the user experience service, and the BGP speakers 424, 426 are associated with the connectivity service. These two components work together to support self-service network reconciliation.

In this example of FIG. 4, the ultimate destination is the application 410, reachable via the ISP-2 404 or the ISP-3 406, both through the ISP-1 402 connected to the cloud-based system 100, via the routers 420, 422. Assume, the default route is via the ISP-1 402 to the ISP-3 406 via a link 440, and also assume there network service deterioration or degradation is occurring on the link 440, e.g., detected via the user experience techniques described herein. Further, assume the first mile connections, i.e., between the endpoint 102 and the cloud-based system 100 is operating normal (not shown).

Also, for illustration purposes, the router 420 and the BGP speaker 424 are in one data center (DC), and the router 422 and the BGP speaker 426 are in another data center. Also, the SDN controller 430 can be in a third data center, as well as one of the same data centers. Of course, those skilled in the art will recognize a practical cloud-based system 100 could have dozens or hundreds of different data centers, geographically dispersed.

Ideally, to improve user experience, the cloud-based system 100 should reroute around the degraded link 440, but it is challenging for the nodes 150, the routers 422, 424, etc. to reroute traffic to different ISPs beyond the default route dictated by the routing peers. This is primarily due to the inherent limitations and rigidity of the current interdomain routing infrastructure. Internet routing between different autonomous Systems is governed by BGP, which relies on pre-established peering agreements, static route advertisements, and policy-driven decision-making rather than real-time performance metrics. The present disclosure provides an approach to detect degradation on the degraded link 440, for the application 410, and to implement a smart routing algorithm to reroute via the link 442 through a different ISP-2 404.

Under BGP, each AS announces what IP prefixes it can reach, and neighboring ASes select paths based on attributes like AS Path length, local preference, and various route policies. These policies are often designed around commercial agreements, regulatory constraints, or stable global routing rather than optimal performance. As a result, rerouting traffic to a different ISP at will—especially to overcome transient issues such as congestion or increased latency—would mean overriding or renegotiating these existing policies. Moreover, the global routing system lacks a built-in feedback mechanism for dynamically detecting and circumventing poor performance. Any changes to BGP routes, even if intended to improve quality, can trigger wide-scale instability or complex ripple effects across multiple networks.

To provide self-service network reconciliation, the SDN controller 430 can be run within the cloud-based system 100 to provide user experience-driven routing decisions, while dedicated BGP speakers 424, 426 handle the actual external routing configurations for the endpoints 102. The SDN controller 430 communicates with these BGP speakers 424, 426 through standardized APIs such as gRPC or other protocol interfaces, allowing it to issue routing directives based on continuously monitored performance and user experience metrics.

The BGP speakers 424, 426 peer with local data center (DC) routers 420, 422 using standard BGP sessions. In doing so, they receive route advertisements from the local DC infrastructure and determine the “best route” for any given destination. They can enforce routing preferences through various techniques, such as policy-based routing (PBR), manipulating route attributes (e.g., Local Preference, multiple exit discriminator (MED)), setting higher route priorities, applying AS-path filters, or leveraging other parameters and capabilities of native routing protocols. Additionally, they can integrate with routing software development kits (SDKs), OpenFlow, or other SDN-compatible methods to dynamically adjust route selection. By doing so, the BGP speakers 424, 426 effectively become programmable conduits—translating the SDN controller's 439 high-level instructions into concrete BGP updates that influence end-to-end traffic flows.

In an embodiment, the process works as follows:
(1) Route Discovery and Reporting: The BGP speakers 424, 426 continuously learn new routes and evaluate the current routing environment. When a BGP speaker 424, 426 identifies a route change, it can append data center identifiers (DC-IDs) or other metadata—possibly encoded within specific message types or TLVs (Type-Length-Value structures)—to indicate which data center or node is associated with that route.
(2) SDN Controller Analysis: The SDN controller 430 aggregates user experience scores and other performance metrics (e.g., latency, jitter, packet loss) collected from across the network. Upon receiving updated routing information (including DC-IDs) from the BGP speakers, it correlates these routes with the observed user experience metrics, default routing paths, and previously defined Service-Level Agreements (SLAs).
(3) Detection of Degradation and Route Optimization: If the SDN controller 430 detects network service degradation—such as excessive latency or packet loss impacting premium customers—it triggers a “smart routing” algorithm. This algorithm analyzes alternative routes and compares them against the default path, determining which alternate paths could restore or improve the user experience.
(4) Policy Distribution and Route Injection: After selecting a more optimal route, the SDN controller updates the routing policies accordingly. These updates can be published through a centralized configuration mechanism—sometimes referred to as “PAC config” (Policy and Configuration)—which distributes new routing instructions to the relevant BGP speakers 424, 426. The BGP speakers then propagate these policy changes into the routing domain by adjusting attributes in their outgoing BGP advertisements. For instance, they may increase the Local Preference for a preferred route or filter out a suboptimal path. This can redirect traffic for specific endpoints 102 to different nodes 150 or data centers (DCs), ensuring that customers experience improved performance.
(5) Continuous Monitoring and Feedback Loop: As the new routes take effect, the SDN controller 430 continues to monitor user experience metrics and network telemetry. If conditions improve, the updated routes remain in place. If problems persist or shift elsewhere, the SDN controller can refine policies and push further adjustments, maintaining an ongoing feedback loop to sustain optimal service quality.

By implementing this combination of SDN-based intelligence, standardized BGP interactions, and adaptive routing policies, the cloud-based system 100 can dynamically steer traffic toward better-performing segments of the network. This proactive approach helps uphold SLAs and enhances the overall user experience, especially for premium customers who depend on consistently high-quality connectivity.

In a further, more detailed embodiment, the process includes:
(1) Initial Route Discovery: The BGP speakers 424, 426 peer with local data centers (DCs) (i.e., the routers 420, 422) and continuously learn new routes via standard BGP sessions, collecting information about available paths and attaching identifiers (e.g., DC-IDs or TLVs) to indicate where each route originates.
(2) Route and Performance Reporting: The BGP speakers 424, 426 share these learned routes, along with associated DC metadata, with the SDN controller 430 through a standardized interface (e.g., gRPC). At the same time, the SDN controller 430 gathers user experience metrics (e.g., latency, jitter, packet loss) and performance data from the cloud-based system 100.
(3) Correlation and Analysis: The SDN controller 430 correlates the routes received from the BGP speakers 424, 426 with the real-time user experience metrics. It compares the existing default routes against the measured performance indicators to determine if the current forwarding paths are meeting the desired SLAs, especially for premium customers.
(4) Detection of Service Degradation: If the SDN controller 430 detects that certain routes are causing degraded user experiences—due to congestion, high latency, or packet loss—it identifies the need for route optimization.
(5) Smart Routing Algorithm Execution: The SDN controller 430 runs a “smart routing” algorithm, evaluating alternative routes and potential changes to policy-based routing (PBR), route attributes (e.g., Local Preference, MED), or AS-path filters. It selects a more optimal path that can improve user experience and meet SLA requirements.
(6) Policy Distribution and Route Injection: Once a better route is determined, the SDN controller 430 updates routing policies and communicates these changes back to the BGP speakers 424, 426. Through configurations or policy updates (e.g., “PAC config”), the BGP speakers 424, 426 adjust their BGP advertisements, potentially changing route priorities, filtering suboptimal paths, or favoring new ones.
(7) Traffic Redirection: The endpoints 102 are redirected along the newly selected routes. The BGP speakers 424, 426 may instruct nodes 150 to forward traffic through different DCs or service nodes that yield improved performance metrics.
(8) Continuous Monitoring and Feedback Loop: After rerouting, the SDN controller 430 continues to measure user experience. If conditions improve, the updated routing remains. If performance issues persist or emerge elsewhere, the SDN controller 430 iterates the process, continually refining routing decisions to maintain an optimal end-to-end user experience.

### Process

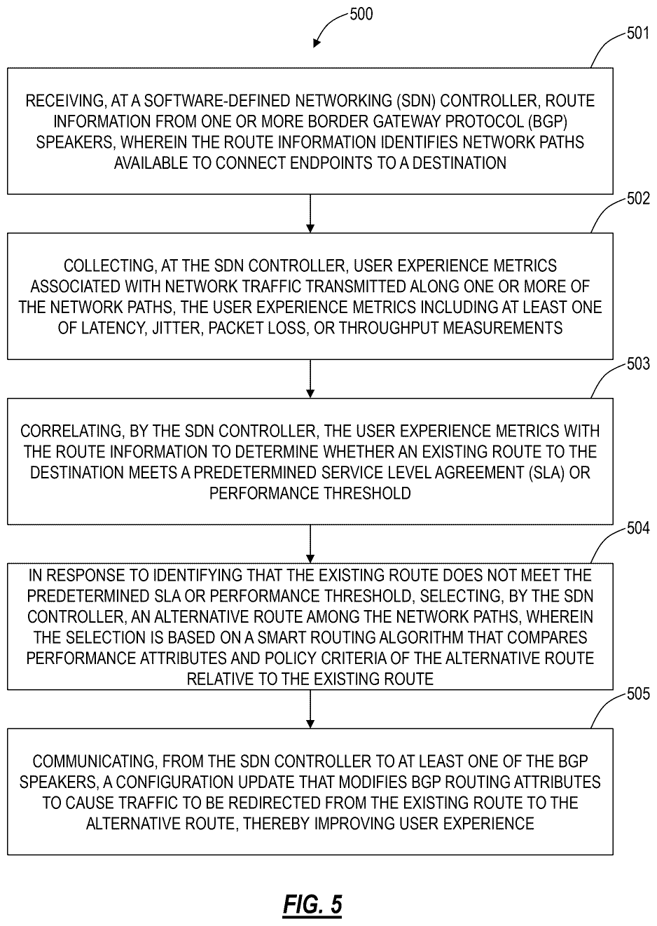

FIG. 5 illustrates a flowchart of a process 500 for dynamically optimizing network routes in a cloud-based system 100. The process 500 contemplates implementation as a method having steps, via the SDN controller 430 configured to implement the steps, and as a non-transitory computer-readable medium storing instructions that, when executed, cause one or more processors to implement the steps.

The steps include receiving, at a software-defined networking (SDN) controller, route information from one or more Border Gateway Protocol (BGP) speakers, wherein the route information identifies network paths available to connect endpoints to a destination (step 501); collecting, at the SDN controller, user experience metrics associated with network traffic transmitted along one or more of the network paths, the user experience metrics including at least one of latency, jitter, packet loss, or throughput measurements (step 502); correlating, by the SDN controller, the user experience metrics with the route information to determine whether an existing route to the destination meets a predetermined service level agreement (SLA) or performance threshold (step 503); in response to identifying that the existing route does not meet the predetermined SLA or performance threshold, selecting, by the SDN controller, an alternative route among the network paths, wherein the selection is based on a smart routing algorithm that compares performance attributes and policy criteria of the alternative route relative to the existing route (step 504); and communicating, from the SDN controller to at least one of the BGP speakers, a configuration update that modifies BGP routing attributes to cause traffic to be redirected from the existing route to the alternative route, thereby improving user experience (step 505).

In one embodiment, selecting the alternative route may involve adjusting route attributes—such as local preference, MED values, or AS-path filters—to favor the improved route over the existing one. The user experience metrics can be derived from periodically executed synthetic probes or traces that measure key performance indicators between the endpoints and the destination. The SDN controller communicates with the BGP speakers through a standardized API, allowing it to receive route information and deliver updated routing policies in real time. Once traffic is redirected, the SDN controller can periodically re-evaluate the chosen alternative route and, if necessary, select a new one to maintain or improve user experience. Configuration updates to the BGP speakers can be performed through a centralized PAC mechanism, enabling simultaneous distribution of routing changes to multiple nodes.

Additionally, the correlation between user experience metrics and route information may involve mapping network paths to DC-IDs or other topology metadata, enhancing the granular identification of problematic route segments. The smart routing algorithm can incorporate historical performance data, anticipated traffic patterns, or administrator-defined priorities when selecting alternative routes. Furthermore, this approach enables identifying when multiple Tier 1 or Tier 2 carriers cause congestion, prompting adjustments to route attributes that steer traffic through different carriers. Finally, the SDN controller may maintain a comprehensive record of all route adjustments and associated improvements in user experience, supporting auditing processes and guiding future optimization efforts.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for dynamically optimizing network routes in a cloud-based system comprising:
receiving, at a software-defined networking (SDN) controller, route information from one or more Border Gateway Protocol (BGP) speakers, wherein the route information identifies network paths available to connect endpoints to a destination;
collecting, at the SDN controller, user experience metrics associated with network traffic transmitted along one or more of the network paths, the user experience metrics including at least one of latency, jitter, packet loss, or throughput measurements;
correlating, by the SDN controller, the user experience metrics with the route information to determine whether an existing route to the destination meets a predetermined service level agreement (SLA) or performance threshold;
in response to identifying that the existing route does not meet the predetermined SLA or performance threshold, selecting, by the SDN controller, an alternative route among the network paths, wherein the selection is based on a smart routing algorithm that compares performance attributes and policy criteria of the alternative route relative to the existing route; and
communicating, from the SDN controller to at least one of the BGP speakers, a configuration update that modifies BGP routing attributes to cause traffic to be redirected from the existing route to the alternative route, thereby improving user experience.

2. The method of claim 1, wherein the selecting the alternative route further comprises adjusting route attributes including at least one of local preference, MED (Multi-Exit Discriminator) values, or AS-path filters to favor the alternative route over the existing route.

3. The method of claim 1, wherein the user experience metrics are derived from synthetic probes, traces, or Real User Monitoring interfaces executed periodically to measure performance between the endpoints and the destination.

4. The method of claim 1, wherein the SDN controller communicates with the BGP speakers using a standardized application programming interface (API) or BGP transmission control protocol (TCP) sessions to receive route information and deliver updated routing policies.

5. The method of claim 1, further comprising the SDN controller periodically re-evaluating the alternative route after traffic has been redirected, and if necessary, selecting a new route to maintain or improve user experience.

6. The method of claim 1, wherein the configuration update to the BGP speakers is performed through a centralized policy and configuration (PAC) mechanism that distributes routing changes to multiple nodes simultaneously.

7. The method of claim 1, wherein the correlation between user experience metrics and route information includes mapping network paths to data center identifiers (DC-IDs) or other topology metadata, including hosted application services, enabling more granular identification of route segments contributing to performance degradation.

8. The method of claim 1, wherein the smart routing algorithm incorporates historical performance data, anticipated traffic patterns, or weighted priorities set by administrators to select the alternative route.

9. The method of claim 1, further comprising identifying when multiple Tier 1 or Tier 2 carriers introduce congestion along the existing route and responsively modifying the route attributes to select an alternative path through different carriers.

10. The method of claim 1, wherein the SDN controller stores and maintains a record of all route adjustments and corresponding user experience improvements for auditing and future route optimization decisions.

11. A software-defined networking (SDN) controller comprising:
one or more processors, and memory storing instructions that, when executed, cause the one or more processors to
receive route information from one or more Border Gateway Protocol (BGP) speakers, wherein the route information identifies network paths available to connect endpoints to a destination;
collect user experience metrics associated with network traffic transmitted along one or more of the network paths, the user experience metrics including at least one of latency, jitter, packet loss, or throughput measurements;
correlate the user experience metrics with the route information to determine whether an existing route to the destination meets a predetermined service level agreement (SLA) or performance threshold;
in response to identifying that the existing route does not meet the predetermined SLA or performance threshold, select an alternative route among the network paths, wherein the selection is based on a smart routing algorithm that compares performance attributes and policy criteria of the alternative route relative to the existing route; and
communicate, to at least one of the BGP speakers, a configuration update that modifies BGP routing attributes to cause traffic to be redirected from the existing route to the alternative route, thereby improving user experience.

12. The SDN controller of claim 11, wherein the alternative route is selected by adjusting route attributes including at least one of local preference, MED (Multi-Exit Discriminator) values, or AS-path filters to favor the alternative route over the existing route.

13. The SDN controller of claim 11, wherein the user experience metrics are derived from synthetic probes, traces, or Real User Monitoring interfaces executed periodically to measure performance between the endpoints and the destination.

14. The SDN controller of claim 11, wherein the SDN controller communicates with the BGP speakers using a standardized application programming interface (API) or BGP transmission control protocol (TCP) sessions to receive route information and deliver updated routing policies.

15. The SDN controller of claim 11, wherein the SDN controller is configured to periodically re-evaluate the alternative route after traffic has been redirected, and if necessary, selecting a new route to maintain or improve user experience.

16. The SDN controller of claim 11, wherein the configuration update to the BGP speakers is performed through a centralized policy and configuration (PAC) mechanism that distributes routing changes to multiple nodes simultaneously.

17. The SDN controller of claim 11, wherein the correlation between user experience metrics and route information includes mapping network paths to data center identifiers (DC-IDs) or other topology metadata, including hosted application services, enabling more granular identification of route segments contributing to performance degradation.

18. The SDN controller of claim 11, wherein the smart routing algorithm incorporates historical performance data, anticipated traffic patterns, or weighted priorities set by administrators to select the alternative route.

19. The SDN controller of claim 11, wherein the SDN controller is configured to identify when multiple Tier 1 or Tier 2 carriers introduce congestion along the existing route and responsively modify the route attributes to select an alternative path through different carriers.

20. The SDN controller of claim 11, wherein the SDN controller stores and maintains a record of all route adjustments and corresponding user experience improvements for auditing and future route optimization decisions.
